(19) United States
(12) Patent Application Publication
(10) Pub. No.: US 2007/0099527 A1
(43) Pub. Date: May 3, 2007

(54) Method and reactor to coat fiber tows and article

(75) Inventors: Milivoj Konstantin Brun, Ballston Lake, NY (US); Krishan Lal Luthra, Schenectady, NY (US); Henry Charles McGuigan, Duanesburg, NY (US); Gregory Scot Corman, Ballston Lake, NY (US)

Correspondence Address: GENERAL ELECTRIC COMPANY;GLOBAL RESEARCH, PATENT DOCKET RM. BLDG. K1-4A59, NISKAYUNA, NY, 12309, US

(73) Assignee: General Electric Company, Schenectady, NY (US)

(21) Appl. No.: 11/263,715

(22) Filed: Nov. 1, 2005

(51) Int. Cl. B32B 17/02; D03D 15/00; B32B 5/08; D04H 3/05; D04H 1/74

(52) U.S. Cl. 442/185; 442/218; 442/219; 442/269; 442/366; 442/368

(57) ABSTRACT

In a method of coating a CMC fiber, a multiplicity of fiber tows aligned as a ribbon are simultaneously passed through a reactor and a flow of fiber coating reactant is passed though the reactor to coat the tow fibers. A coating system comprises a reactor chamber to accommodate a multiplicity of fiber tows passing along a path substantially parallel to a longitudinal axis of the chamber and a flow of fiber coating reactant and an aligning structure at an end of the chamber to maintain the multiplicity of fiber tows in a narrow, elongated ribbon configuration. An article comprises a multiplicity of fiber tows aligned in a longitudinal planar array in the form of a ribbon.

This invention was first conceived or reduced to practice in the performance of work under contract DE-FC02-92CE41000 with the United States Department of Energy. The United States of America may have certain rights to this invention.

### BACKGROUND OF THE INVENTION

The invention relates to a method and reactor for applying a coating to a fiber by chemical vapor deposition (CVD). Also, the invention relates to an article comprising a multiplicity of fiber tows.

Fiber reinforced ceramic matrix composites (CMCs) are formed of continuous uniaxial or woven fibers of ceramic material embedded in a ceramic matrix. These materials are designed to have a relatively weak fiber-matrix bond strength compared to the matrix strength so as to increase overall composite strength and toughness. When the CMC is loaded above a stress that initiates cracks in the matrix, the fibers debond from the matrix allowing fiber/matrix sliding without fiber fracture. The fibers can then bridge a matrix crack and transfer load to the surrounding matrix by transferring tensile stresses to frictional interfacial shear forces. The fiber reinforced CMCs have great potential for use in aircraft and gas turbine engines due to their excellent properties at high temperatures.

The CMCs can be manufactured by filament winding. In this process, fibers, usually in the form of long fiber tows, are saturated with a slurry of matrix powder in suitable solvents and binders and are then wound onto a mandrel to form cylinders or sheets of matrix containing aligned fibers. The impregnated shapes made therefrom are at this stage of the process commonly termed “prepregs.” A prepreg can be reshaped as desired and ultimately formed into a preform for a composite article. The preform is subjected to a burn-out step to remove organic or other fugitive coating components. The preform is finally consolidated into a dense composite material by reaction with molten silicon at high temperature.

The fibers are coated for several purposes such as to protect them during composite processing, to modify fiber-matrix interface strength and to promote or prevent mechanical and/or chemical bonding of the fiber and matrix. A number of different techniques have been developed for applying fiber coatings, such as slurry-dipping, sol-gel, sputtering and chemical vapor deposition (CVD). Of these, CVD has been most successful in producing impervious coatings of uniform thickness and controlled composition. In a typical CVD process, fibers and reactants are heated to some elevated temperature where coating precursors decompose and deposit as a coating. CVD coatings can be applied either in a batch or continuous mode. In a batch mode, a length of fiber is introduced into a reactor and kept stationary throughout the coating process while reactants are passed through the reactor. In a continuous process, fibers and coating precursors are continuously passed through a reactor. Continuous fiber coating processes are preferred for composites processed by filament winding.

One common continuous fiber coating process involves running a single tow or fiber into the reactor at a time. The coating is conducted at low pressure to insure uniform coating. The tow or fiber is transported through the reactor only at a slow speed. Although current processes provide useful results, there remains a need for further improvements to CVD processes for uniformly coating fiber tows with higher productivity.

### BRIEF SUMMARY OF THE INVENTION

The invention provides a method and reactor to uniformly coat fibers at improved throughput. According to the invention, a method of coating fiber comprises simultaneously passing a multiplicity of fiber tows aligned as a ribbon through a reactor and passing a flow of fiber coating reactant though the reactor to coat the tow fibers.

In an embodiment, a coating system comprises a reactor chamber to accommodate a multiplicity of fiber tows passing along a path substantially parallel to a longitudinal axis of the chamber and a flow of fiber coating reactant and an aligning structure at an end of the chamber to maintain the multiplicity of fiber tows in a narrow, elongated ribbon configuration.

In another embodiment, an article comprises a multiplicity of fiber tows aligned in a longitudinal planar array in the form of a ribbon.

### BRIEF DESCRIPTION OF THE DRAWINGS

FIG. 1 is a schematic representation of a reactor to simultaneously coat a multiplicity of fiber tows;

FIG. 2 is a schematic representation of a multiplicity of fiber tows aligned with a spacer tape for loading to a take-up spool;

FIG. 3 is a schematic representation of aligning and tensioning structures with a reactor; and

FIG. 4 is a schematic representation of a disrupter reactor.

### DETAILED DESCRIPTION OF THE INVENTION

Ceramics have excellent heat resistance, corrosion resistance and heat insulating properties in comparison to metal materials. Hence, ceramics can be used as structural materials in place of metals in harsh high temperature or corrosive environments. However, ceramics cannot be deformed in the same way as metal materials. In a ceramic, stress becomes concentrated on defects in the material and flaws on the material surface. Fibers can be dispersed in a matrix of the ceramic to improve its toughness. The present invention generally relates to fibers, including those that are adapted for use as a reinforcement phase in a composite ceramic. Such fibers, when disposed in a CMC, prevent catastrophic failure of a CMC by debonding and bridging cracks as matrix fracture occurs.

Typically, the fibers are provided with a continuous coating to control interfacial shear strength between the fibers and the ceramic material. The coating can be applied by CVD. For example, Corman, U.S. Pat. No. 6,168,827 discloses a method for applying a CVD coating to reinforcing fibers arranged into a tow or cloth. The method comprises aligning the tow or cloth with an adjacent separation layer of a porous non-woven chopped fiber material. The chopped fiber separation layer has a porosity of at least about 85%. The tow or cloth and the separation layer are wound onto a support structure. The tow or cloth and layer are wound in an interleaved manner so that the layer separates a wrap of the tow or cloth from an adjacent wrap of the tow or cloth. The support structure with wound materials is then placed into a CVD deposition furnace where the tow or cloth is coated.

Dietrich et al., U.S. Pat. No. 4,657,776 teaches another process in which fiber tows are fanned out into carrier ribbons comprising strands of single fibers. The ribbons are passed through the center of the furnace chamber while a reactant gas is injected either counter to or in the same direction as movement of the ribbons and substantially parallel to the ribbons.

According to the invention, fiber tows are arranged into ribbons of tows for continuous processing in a CVD furnace. The term “tow” means “[a] large number of continuous filaments collected in ropelike form . . . .” McGraw-Hill dictionary of Scientific and Technical Terms, 5^{th} Ed. page 2048, 1994. In this application, “tow” means a plurality of fiber filaments collected in a ropelike form and “plurality of fiber filaments” means at least more than a single fiber filament and “ribbon” means a longitudinal planar array of multiple tows.

In the inventive process, the tows are separated by sufficient spacing to assure uniform coating of fibers in each tow. Spacing of the fiber tows in the ribbon can be the same as a desired spacing in the composite preform. For example, the spacing is about 0.5 mm to about 25 mm in some embodiments, about 0.625 mm to about 10 mm in certain embodiments, and about 0.9 mm to about 5 mm in particular embodiments.

Because a large number of fiber tows can be passed through the coating furnace together, throughput of the process is greatly improved. Improved throughput results in lower coating cost. The process of the invention differs from standard coating practice in that it passes a planar array of aligned fiber tows through the furnace. The process requires only a single drive mechanism. By providing high density packing, the invention makes it possible to coat a large number of fiber tows in a furnace of relatively small cross section.

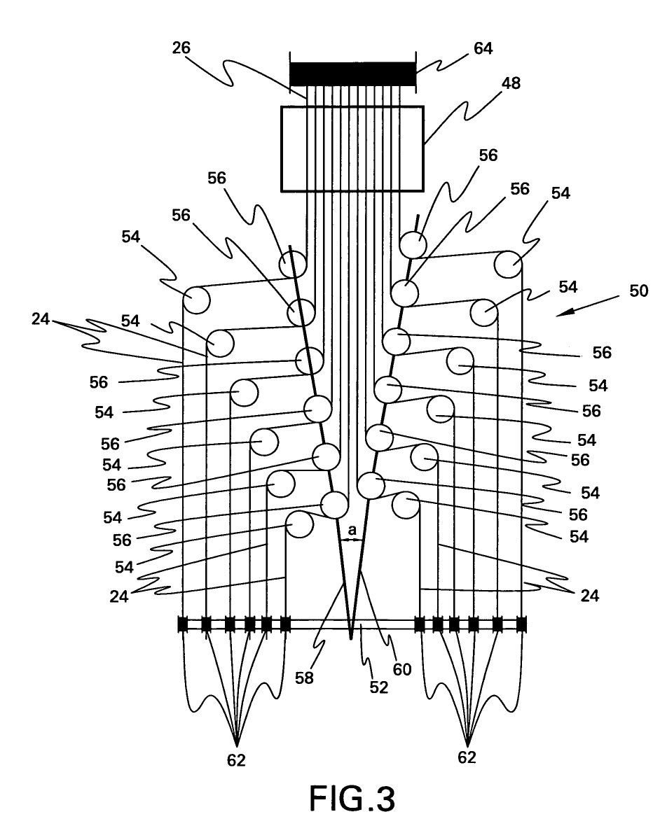

The tows can be arranged in the form of a ribbon by first winding them together onto a common spool. The degree to which precursor gas can penetrate fiber tow can depend on the tension applied to the tow. Uniformly tensioned tows promote the fabrication of uniformly coated individual fibers. Tensioning devices can be controlled during winding to provide uniformly tensioned tows on a common spool. For example, the tows can be fed through an aligning device as shown in FIG. 3 to provide a parallel ribbon array with controlled spacing and uniform tension.

A “fugitive” binder can be used to hold the tows together in ribbon form for ease of handling. Suitable binders include polymeric binders, such as epoxies, polyvinyl alcohol, etc. Preferably, a binder is selected that will decompose “cleanly” upon heating, meaning that it will not leave significant amount of residue on the fiber. Suitable decomposing binders include acrylate polymers such as polymethylmethacrylate. These polymers “unzip” when heated—they depolymerize back to monomers, which readily volatilize, leaving no residue on the tow fibers. The binder can be applied to the tows as solution in a suitable solvent. It can be applied to individual tows or to the aligned tow array by passing the fibers through a binder solution, or by spraying binder solution onto the tows.

In another embodiment, the fiber tows can be held in ribbon form by weaving, stitching or braiding to impart strength in an orthogonal or substantially orthogonal direction. The weaving or stitching can be temporary and can be removed subsequent to the coating process. Weaving can be accomplished by running a set of fibers (secondary fibers or tows) substantially orthogonal to the longitudinal tows at periodic intervals along the ribbon. The secondary fiber or tow must be stable under coating conditions, meaning that it should not decompose or react with the longitudinal tow and should not react with reactants involved in the coating step. The secondary fiber can be the same material as the longitudinal tows or the fiber can be different. For example, a carbon fiber or tow can be used to hold together silicon carbide tows. Other examples of suitable secondary fibers include fibers made from thermodynamically stable oxides, carbides and nitrides.

After coating, the ribbon tows can be processed into a composite preform. The ribbons can be separated into individual tows, which can be processed by filament winding or lay-up techniques. Alternatively, the ribbons can be processed directly into a preform by ribbon winding. Ribbon winding is similar to single tow winding. The winding can be either wet or dry winding. In wet winding, the ribbon is run through a bath of matrix slurry until saturated. Matrix slurry is a suspension of matrix particles in a solution of organic binders in a suitable solvent. The ribbon can then be wound onto a preform mandrel as a unit. Winding pitch (the length by which the preform mandrel is moved per each winding revolution of the mandrel) is chosen to allow the ribbons to butt against adjacent ribbons without overlapping. Overlapping of tows can result in thickening of the piece at the area of overlap. Generally, pitch is selected to be very close to the width of the ribbon.

Ribbon winding is much faster than the winding of single fiber filaments. If for example, a ribbon consists of 10 tows, it can be wound at 10 times greater pitch than a single tow or fiber. Consequently, a wound piece can be produced in a tenth of the time necessary for single tow or filament winding. Otherwise, the winding parameters for ribbon tow winding, such as fiber speed, tension etc do not significantly differ from parameters of single tow winding.

The tow ribbons can be processed into composite preforms by prepregging of individual ribbons. The ribbons are saturated with matrix slurry by passing through a slurry or by spraying slurry onto the ribbons. The ribbons can be dried for handling and formed into desirable shapes by hand- or machine-placing partially or fully dried ribbons into a preform shape. The preforms can then be consolidated by autoclaving.

Fibers that are available in tows can have a diameter of 4-25 microns. A fiber tow can contain from 50 to 12000 fibers, depending on fiber type, size and intended use. Numerous fibers are available in the form of a tow. These fibers range in composition from glasses to polycrystalline materials. Suitable fibers include oxide, silicon carbide and silicon nitride types. Other suitable types include glass fibers (fiberglass composites) and carbon fibers. Several types of polycrystalline oxide fibers are suitable and are commercially available.

Silicon carbide fiber tows are produced by spinning fibers from a polymer precursor, curing and converting the fibers to nearly pure silicon carbide by subsequent heat treatment. Commercially available silicon carbide fibers typically range in size from about 8 to 14 microns and are available in tows containing from 400 to 800 fibers. The silicon carbide-based fibers are of particular interest for composites described in present invention. However, the invention can be used to coat any fiber tow.

The coating method of the invention can be a continuous coating process. In the continuous process, fibers are passed through a furnace, which is held at an elevated temperature. A constant flow of precursor gas is maintained through the furnace. Gas decomposes at about 700° C. to about 1800° C. temperature and reacts and deposits to form a coating on the fiber tows. Desirably, the temperature is about 1000° C. to about 1650° C. and preferably about 1250° C. to about 1550° C.

The number of fiber tows being coated simultaneously varies with the size of the CVD chamber. For example, a typical furnace can accommodate from one to about 25 fiber tows. Tow fiber spacing, as used herein, means the distance from the center of a fiber in a tow to the center of its nearest neighboring fiber. This tow fiber spacing is about 0.5 mm to about 25 mm in some embodiments, about 0.625 mm to about 10 mm in certain embodiments, and about 0.9 mm to about 5 mm in particular embodiments.

The speed at which fibers are transported through the furnace is dependent on the type of coating being applied, desired thickness and the length of deposition zone in the furnace. A typical rate, in some embodiments, is from about 25 to about 5000 mm/minute. In certain embodiments, the rate is from about 125 to about 4000 mm/min, and in particular embodiments the rate is from about 150 to about 2500 mm/minute.

The reactant gases that are used are determined by the desired coating. Those skilled in the art are familiar with the selection of precursors and processing parameters for depositing coatings onto substrates using various chemical vapor deposition processes. Some coatings are produced by decomposition of a single reactant gas. For example, deposition of carbon is typically accomplished by decomposition of a hydrocarbon, such as methane. The decomposition reaction can be described by the following:
CH₄->C+2H₂

A two-gas reaction can be used for other coatings, such as a boron trichloride and ammonia reaction to form boron nitride:
BCl₃+NH₃→BN+3HCl

A three-gas reaction can be used, such as a boron trichloride, ammonia and a silicon precursor to produce silicon-doped boron nitride. Silicon precursors include dichlorosilane, trichlorosilane, silicon tetrachloride and silane. For example, trichlorosilane and ammonia may be suitable precursors for silicon nitride coatings. Hydrogen or nitrogen, which may not be directly involved in the chemical deposition reaction, can be used to dilute precursor gases to control reaction speed and temperature. Moreover, coatings of multiple layers (same or different compositions) may be deposited on the fiber by, for instance, performing multiple passes through a reactor or passing the fiber through multiple reactors. Various combinations of coating layers may be applied to the fiber to control interfacial properties and to improve protection of the fiber during molten silicon infiltration. These combinations may consist of two, three, four, or more layers. Examples of four-layer combinations include boron nitride/silicon-doped boron nitride/silicon nitride/carbon; and boron nitride/carbon/silicon nitride/carbon. Examples of three-layer combinations include boron nitride/silicon nitride/carbon; and boron nitride/silicon-doped boron nitride/carbon. An exemplary two-layer combination is boron nitride/carbon. None of these exemplary combinations should be read as limiting the invention.

The thickness of coating deposited on a fiber is dependent on a number of factors such as tow speed, reactor pressure and precursor gas flow rate. The gas flow rate has to be sufficient to provide desired coating thickness on the fiber. The rate depends on the cross section of the reactor, number of tows being coated and their transport rate. The rate can vary from 0.1 to 100 standard liters per minute (slpm). Standard liters per minute means that the gas flow rate is referenced to a measurement made at standard conditions (pressure of 1 atmosphere, temperature of 298° K). This convention is necessary because gas volume changes with pressure and temperature. For a specific reactor having a cross section of about 30 cm², a gas flow rate can be about 0.5 to about 20 slpm.

Reactor pressure determines how fast the precursor gas decomposes. It also has an effect on the mean free path of gas molecules, so it may affect fiber coating thickness uniformity. Operation at a reduced pressure (below atmospheric) is preferred, although not required. Typically, deposition rates decrease with pressure; however, coating thickness tends to be more uniform through a tow or bundle. Reactor pressure can be from about 0.05 Torr to atmospheric pressure (760 Torr). Desirably, the pressure for the process is about 0.1 to about 50 Torr and preferably about 0.3 to about 10 Torr.

These and other features will become apparent from the drawings and following detailed discussion, which by way of example without limitation describe preferred embodiments of the invention.

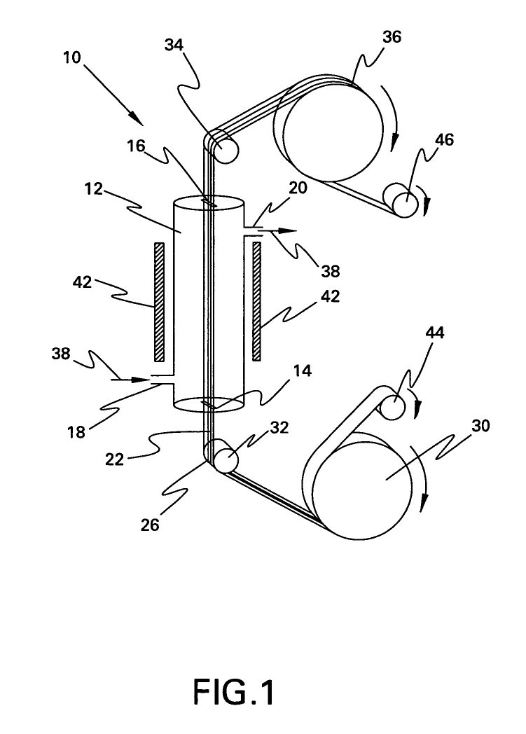

A schematic cross-section drawing of a reactor 10 for a continuous CVD coating process is shown in FIG. 1. The reactor 10 includes a reactor chamber 12, each end of which is terminated by one of a pair of slots 14 and 16. The reactor chamber 12 has a reactant inlet 18 and an exhaust port 20. Each slot, 14, 16 is openable to admit fiber tow ribbon 26.

The tow ribbon 26 comprises a flat, narrow, elongated arrangement of fiber tows 24. The tows 24 are aligned in a spaced apart ribbon configuration; that is, the tows 24 are arranged with parallel longitudinal axis aligned into a narrow horizontal plane. Substantially evenly spaced fiber tows promote substantially uniform coating of the fiber tows.

Fiber tows in a ribbon according to the invention tend to remain well separated if the tows are stabilized such that they remain substantially equally tensioned and aligned. One way of stabilizing the tows is by weaving. In weaving, the alignment of primary fiber is maintained by introducing stabilizing secondary fiber at a right angle to the axis of the primary tows at periodic intervals along the ribbon. As the stabilizing fiber will mask the primary fiber wherever the primary and stabilizing fibers are in contact, thereby inhibiting the formation of the coating at these locations, it is desirable that the selected periodic interval along the ribbon between stabilizing fibers is sufficiently large to provide adequate lengths of uniformly coated primary fiber. In some embodiments, the selected interval is in the range from about 1 mm to about 25 mm.

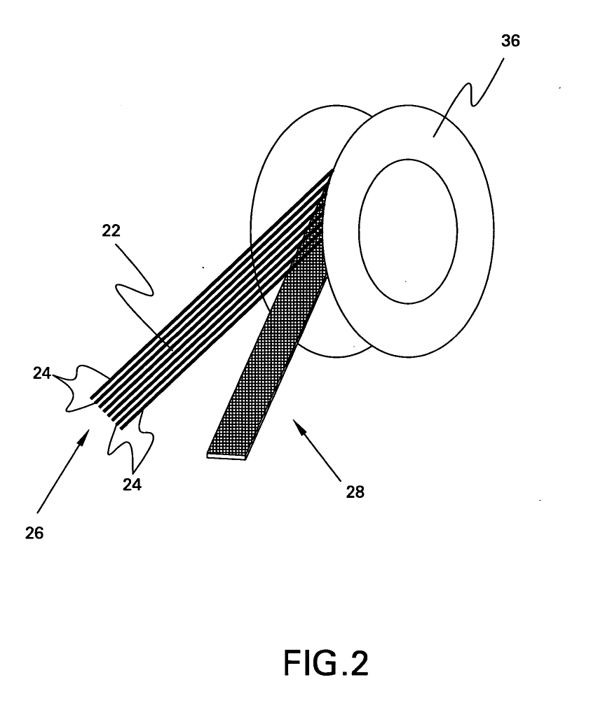

According to another embodiment shown in FIG. 2, the tows 24 are aligned onto a supporting co-aligned spacer base tape 28, either before coating the tows 24 (in which case the tape is removed prior to coating), after coating, or both before and after coating. The spacer base tape 28 can be a polymer film, a paper strip or a metal foil. The spacer base tape 28 prevents fiber tows from being abraded by or tangled with subsequent windings of tows on the spool.

In FIG. 1, ribbon 26 is pulled on-line through reactor chamber 12 for chemical vapor deposition of a coating. The ribbon is made up of multiple fiber tows 24 that are uniaxially aligned as shown. The ribbon 26 is fed from feed spool 30 over guide pulley 32 and through slot 14 and into chamber 12. Take up spool 36 receives coated ribbon 26 as it leaves chamber 12 via slot 16. Spool 44 takes up spacer ribbon 26 as tow ribbon 26 is unwound and fed into reactor chamber 12. Spool 46 includes spacer ribbon, which is fed into the take up spool 36 along with the coated ribbon 26. The reactor chamber 12 is heated by heater 42. The reactor chamber 12 is oriented vertically so that weight of the fiber tow 24 does not produce sag (as it could in a horizontal deposition process). Flow 38 of reactant gas is designated by arrows. The reactor chamber 12 is relatively narrow to ensure that reactant gas flow 38 passes through the reactor chamber 12 in close proximity to the fiber tow ribbon 26 for effective coating.

Tension during coating can be applied by a frictional brake and by friction in the bearings of the fiber transport mechanism (not shown). The tension can be about 5 to about 200 grams per tow, about 5 to about 100 grams per tow in some embodiments, and about 10 to about 100 grams per tow in particular embodiments. In a single tow coating process, one tow has to overcome frictional forces of the transport mechanism. Certain embodiments of the invention reduce tension required for uniform coating by utilizing a single transport mechanism for the multiple tows of a ribbon. With the ribbon configuration described herein, frictional forces are divided over the multiplicity of the ribbon tows.

FIG. 1 shows ribbon 26 being transported from slot 14 through the reactor chamber 12 to exit through slot 16. The particular form of slot 14 and slot 16 permits the feed spool 30, guide pulleys 32 and 34 and take-up spool 36 to operate to draw the ribbon 26 through the reactor chamber. The slots 14 and 16 maintain the fiber tows within a horizontal place in the ribbon 26 form. In this embodiment, the tows are maintained in a ribbon form without the necessity of a backing or spacing. Advantageously then, each tow of the ribbon is completely exposed to reactant gas around its complete circumference.

In the process, continuous lengths of tows 24 in ribbon 26 form are passed through a reactor chamber at a predetermined speed. Reactant gas flow 38 is passed through the chamber. Decomposition of the gaseous reactant results in coating of the fibers of the tow ribbon 26. As reactant in an immediate vicinity of the fiber tow is consumed, additional reactant diffuses from a bulk gas phase. At the same time, gaseous reaction product diffuses away from each fiber tow 24 to create a gradient of reactant and product.

According to the invention illustrated in FIG. 1, improved coating of each fiber tow is obtained since each tow 24 is exposed in its entirety to the reactant gas as the tow passes through the reactor chamber. With some tow material however, it is difficult to retain a tension equilibrium across the entire ribbon and along the ribbon as it is drawn through the length of the reactor chamber. The ribbon 26 may sag and the tows 24 may contact one another to cause spots of incomplete coating. However, stabilization of the ribbon with periodic intervals of stabilizing secondary fibers, as described above, aids in maintaining even spacing between tows, and further assists in the maintenance of uniform tension along the length of the stabilized ribbon. In doing so, stabilization assists in achieving substantially uniform coatings among the individual tows 24.

FIG. 3 is a schematic top view of an aligning structure 50 placed at the charge end of a furnace 48. FIG. 3 shows a single ribbon 26 of twelve fiber tows 24. Individual tows 24 are fed from respective spools 62 through the aligning structure 50 to configure ribbon 26. The respective spools 62 are fed from a tensioning structure 52, which is a common axis for the spools 62. Structure 52 maintains an equal tension on each tow 24. Each tow 24 is threaded around two axially mounted guide pulleys 54 and 56. Inside pulleys 56 are mounted equally spaced on respective rails 58 and 60. The distance between pulleys 56 on rails 58 and 60 and the angle “a” between the rails 58 and 60 can both be adjusted to determine a spacing between the tows 24 making up the ribbon 26. The resulting configured planar parallel array making up the ribbon 26 can then be wound under equal tension onto ribbon spool 64. While pulleys 54 and 56 are shown in FIG. 3, other structures such as stationary fiber guides can be used for aligning the tows 24. Pulleys are preferred structures because they cause less friction and damage to the fiber tows during winding.

The ribbon 26 of tows 24 can be wound on pick-up spool 64 and unwound into reactor chamber 12 as shown in FIG. 1. In the embodiment shown in FIG. 3, furnace 48 is interposed between the aligning structure 50 and the ribbon pick-up spool 64. This embodiment provides for pretreatment of the tows prior to coating. For example, pretreatment can involve removal of fiber sizing (commonly referred to as de-sizing). Sizing is a polymeric coating applied by a fiber tow manufacturer to protect the tows during handling. Removing sizing during pretreatment avoids production of gaseous polymer products inside the CVD reactor. The fiber tows tend to relax as sizing is removed. The extent of relaxation can vary from tow to tow. Winding the tows on pick-up spool 64 under tension and immediately after de-sizing imparts a uniform tension to the ribbon tows—another advantage of the embodiment shown in FIG. 3.

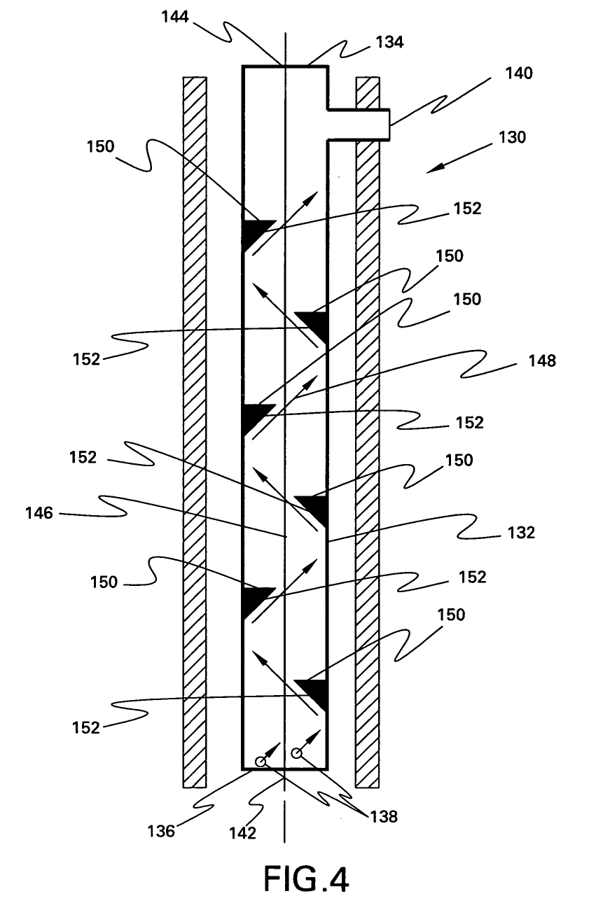

FIG. 4 shows a schematic of a reactor according to one embodiment of the invention. In FIG. 4, the reactor 130 includes a reactor chamber 132, each end of which is terminated by one of a pair of slots 134 and 136. The reactor chamber 132 has a reactant inlet 138 and an exhaust port 140. The slots 134 and 136 enable a fiber tow ribbon 146 to be pulled on-line through the reactor chamber 132 for chemical vapor deposition of a coating. Chamber 132 is equipped with a set of gas flow disrupters 150 positioned along its length. Flow of gas in the chamber is designated 148. The disrupters 150 force gas to flow 148 though the reactor chamber in a convoluted pathway, rather than parallel to the tube axis. In FIG. 4, gas flow disrupters 150 have deflecting faces 152 shown set at an angle of 45° to the furnace axis, thus causing gas to change direction of travel by 90° at each disrupter. The change in direction facilitates uniform coating of the tows in ribbon form.

The following Examples are illustrative and should not be construed as a limitation on the scope of the claims unless a limitation is specifically recited.

### EXAMPLE 1

Twenty-two tows of Nicalon™, a silicon carbide fiber from Nippon Carbon Company, were wound on a spool and installed into a spool box on one end of a CVD reactor. The tows were passed through the CVD reactor as multiple parallel tows under tension and arranged in ribbon form as shown in FIG. 1. Tow spacing was 0.045 inches. The tows were attached to a pick up spool in a receiving box on the opposite end of the CVD reactor. An end box was connected to the reaction chamber by narrow slots, just large enough to pass the tow ribbon. The deposition chamber was a graphite tube of uniform cross section. The chamber had a total of six disrupters in the form of ⅝-inch long wedges attached alternately to opposite sides of the chamber wall as shown in FIG. 4.

The reactor was evacuated and a flow of nitrogen gas was introduced into the reactor chamber through each end box as a seal against reactant leakage. The reactor chamber was heated in accordance with the description above. Reactant gases, boron trichloride and ammonia, were injected into the bottom of the reactor chamber for flow through the chamber in the same direction as the tow bundle. A vacuum pumping system at the top of the chamber expelled spent gas.

Reactant gases were passed at a constant flow rate while the tow ribbon was transported through the chamber in the same direction at constant speed. Boron trichloride and ammonia reacted to form boron nitride, which deposited on the tow (and on furnace wall). Once an entire length of tows of the ribbon was coated, gas flow was stopped and equipment was cooled to room temperature, still under vacuum.

Coated tows were examined in a scanning electron microscope. Examination showed that all fibers in the bundle were coated with boron nitride. The coating thickness of the tows on the periphery of the ribbon was compared to coating thickness on the tows in the center of the ribbon. It was found that average coating thickness of fibers at a tow periphery was about a factor of two greater than the coating thickness in the center of the tow bundle. This result showed that there was good flow of reactant gases through the fiber tows.

### EXAMPLE 2

Eleven 100-meter long tows of Hi-Nicalon™, a silicon carbide fiber from Nippon Carbon Company, were wound on a spool in a parallel arrangement. The tows were then passed through a CVD reactor as multiple parallel fiber tows arranged in ribbon form as described in Example 1. The tows were coated with boron nitride in the manner described in Example 1. After the furnace was cooled to room temperature, a spool with coated tow was transferred into the entrance box of the coated system and an empty take-up spool was installed in the exit box. The tows were passed as a ribbon through the reactor and attached to the take-up spool. The furnace was heated back into the coating temperature range and the tow ribbon was passed through the furnace at a constant rate while a mixture of boron trichloride, trichlorosilane and ammonia was passed through the reactor at the same time. The original boron nitride coating on fibers was thus covered with a coating of boron nitride doped with silicon. The fiber tows were again transferred to the entrance box of the reactor and passed through the furnace again as a ribbon with a mixture of trichlorosilane and ammonia. This step deposited a third coating, silicon nitride, on top of the first two coatings. A final coating, carbon, was deposited on the tow ribbon by passing it through the heated reactor while passing methane gas through the reactor.

The resulting ribbon of coated fiber tows was separated into individual tows and the tows were wound on separate spools. The fiber tows were then processed into composites by first filament winding them to produce sheets containing parallel fibers imbedded in a matrix. The sheets were stacked to yield an 8-ply, 0/90° preform. Binder was burned out and the preform was infiltrated with liquid silicon. The resulting composites were tested under tension. The composites exhibited excellent composite properties. All samples had an ultimate strength in excess of 45 kpsi and a strain-to-failure exceeding 0.8%. By comparison, composite made with improperly coated fibers will typically have strengths below 30 kpsi and strain-to-failure of less than 0.1%. Extensive fiber pullout indicated that the coatings successfully protected fiber during the silicon infiltration step and provided a debond interface between the fibers and the matrix.

### EXAMPLE 3

A ribbon consisting of tows of Hi-Nicalon™ fibers was formed and coated with boron nitride, silicon-doped boron nitride and carbon in the manner described in Example 2. The ribbon containing 5 fiber tows was used for ribbon winding. The ribbon was passed through a bath containing matrix slurry and wound onto a mandrel using a pitch 5 times larger than used for a single tow winding. The ribbons were wound longitudinally butting against each other to form a uniform sheet containing aligned fibers in a matrix. The sheet was cut and stacked into an 8-ply, 0/90° composite preform. The preform was autoclaved to burn out binder. Then the preform was infiltrated with molten silicon. The resulting samples exhibited good composite properties when tested in tension, indicating that ribbon processing produced sound composites and did not damage fiber coatings.

While preferred embodiments of the invention have been described, the present invention is capable of variation and modification and therefore should not be limited to the precise details of the Examples. The invention includes changes and alterations that fall within the purview of the following claims.

What is claimed is:

1. A method of coating fibers, comprising:
simultaneously passing a multiplicity of fiber tows aligned as a ribbon through a reactor; and
passing a flow of fiber coating reactant though the reactor to coat the fiber tows.

2. The method of claim 1, wherein the ribbon comprises a parallel arrangement of fiber tows.

3. The method of claim 1, wherein the fiber tows are in a parallel spaced apart relationship, separated by a tow fiber spacing.

4. The method of claim 1, wherein the fiber tows are in a parallel spaced apart relationship, separated by a tow fiber spacing in the range from about 0.5 mm to about 25 mm.

5. The method of claim 4, wherein the tow fiber spacing is in the range from about 0.625 mm to about 10 mm.

6. The method of claim 1, wherein the tow fiber spacing is in the range from about 0.9 mm to about 6 mm.

7. The method of claim 1, wherein the multiplicity of tows is aligned as a ribbon with interwoven stabilizing fibers substantially orthogonal to the tows and disposed at periodic intervals along the ribbon.

8. The method of claim 1, wherein the multiplicity of tows is aligned and held in the form of a ribbon by a binder.

9. The method of claim 1, wherein the multiplicity of tows is aligned and held in the form of a ribbon by a polymethylmethacrylate binder.

10. The method of claim 7, wherein the stabilizing fibers comprise the same material as at least one of the fiber tows.

11. The method of claim 7, wherein the stabilizing fibers comprise a different material from a material of the fiber tows.

12. The method of claim 1, wherein the multiplicity of tows is aligned as a ribbon with equal spacing between each tow of the multiplicity.

13. The method of claim 1, wherein the multiplicity of fiber tows is aligned as a ribbon of fiber tows with interwoven cross tows of stabilizing fibers disposed at periodic intervals along the ribbon.

14. The method of claim 1, wherein the reactor is a CVD reactor chamber.

15. The method of claim 1, wherein the reactor is a CVD reactor chamber and the fiber is passed through a first slot through the CVD reactor chamber to discharge at a second slot of the reactor.

16. The method of claim 1, wherein the fiber tows comprise silicon carbide fibers.

17. The method of claim 1, wherein the fiber tows comprise aluminum oxide fibers.

18. The method of claim 1, wherein the fiber coating reactant comprises a hydrocarbon.

19. The method of claim 1, wherein the fiber coating reactant comprises methane.

20. The method of claim 1, wherein the fiber coating reactant comprises boron trichloride and ammonia.

21. The method of claim 1, wherein the fiber coating reactant comprises boron trichloride, ammonia and a silicon precursor.

22. The method of claim 21, wherein the silicon precursor is selected from dichlorosilane, trichlorosilane, silicon tetrachloride and silane.

23. The method of claim 1, wherein the fiber coating reactant includes hydrogen or nitrogen.

24. The method of claim 1, wherein the fiber coating reactant is passed through the reactor at a temperature from about 700° to about 1800° C. and reacts and deposits to form a coating on the fibers of the tows.

25. The method of claim 1, wherein the fiber coating reactant is passed through the reactor at a temperature from about 1000° to about 1650° C. and reacts and deposits to form a coating on the fibers of the tows.

26. The method of claim 1, wherein the fiber coating reactant is passed through the reactor at a temperature from about 1250 to about 1550° C. and reacts and deposits to form a coating on the fibers of the tows.

27. The method of claim 1, wherein the reactor is maintained at a pressure about 0.05 Torr to about atmospheric pressure (760 Torr).

28. The method of claim 1, wherein the reactor is maintained at a pressure about 0.1 to about 50 Torr.

29. The method of claim 1, wherein the reactor is maintained at a pressure about 0.3 to about 10 Torr.

30. The method of claim 1, wherein the reactor is maintained at temperature of about 700° to about 1800° C.

31. The method of claim 1, wherein the reactor is maintained at temperature of about 1000° to about 1650° C.

32. The method of claim 1, wherein the reactor is maintained at temperature of about 1250° to about 1550° C.

33. The method of claim 1, wherein a tow of fibers is passed through the reactor and the fibers of the tow are spaced apart about 0.5 mm to about 25 mm.

34. The method of claim 1, wherein a tow of fibers is passed through the reactor and the fibers of the tow are spaced apart about 0.625 mm to about 10 mm.

35. The method of claim 1, wherein a tow of fibers is passed through the reactor and the fibers of the tow are spaced apart about 0.9 mm to about 6 mm.

36. The method of claim 1, wherein the tow of fibers is passed through the reactor at a rate from about 25 to about 5000 mm/minute.

37. The method of claim 1, wherein the tow of fibers is passed through the reactor at a rate from 125 to about 4000 mm/min.

38. The method of claim 1, wherein the tow is passed through the reactor at a rate from about 150 to about 2500 mm/minute.

39. The method of claim 1, comprising winding a multiplicity of fiber tows onto a single take-up spool prior to passing said multiplicity of the fiber tows as the ribbon through the reactor.

40. The method of claim 39, wherein said multiplicity of fiber tows is wound under tension.

41. The method of claim 42, wherein said multiplicity of fiber tows is wound under tension of about 5 to about 200 grams per tow.

42. The method of claim 42, wherein said multiplicity of fiber tows is wound under tension of about 5 to about 100 grams per tow.

43. The method of claim 42, wherein said multiplicity of fiber tows is wound under tension of about 10 to about 100 g per tow.

44. The method of claim 40, wherein said tension is substantially the same on each fiber tow of the multiplicity of fiber tows.

45. The method of claim 39, comprising pretreating the fiber tows prior to winding onto the take-up spool.

46. The method of claim 45, wherein the pretreating is de-sizing.

47. The method of claim 1, further comprising winding the multiplicity of fiber tows onto a single take up spool subsequent to passing said multiplicity of the fiber tows as the ribbon through the reactor.

48. The method of claim 1, comprising disrupting at least a portion of the flow of reactant from a path substantially parallel to the ribbon.

49. The method of claim 1, further comprising processing the coated fiber tows into a composite preform.

50. The method of claim 1, further comprising processing the coated fiber tows into a composite preform by wet or dry ribbon winding.

51. The method of claim 1, further comprising running the coated fiber tows through a bath of matrix slurry to saturate the tows and winding the saturated tows onto a preform mandrel as a unit.

52. The method of claim 1, further comprising saturating the coated fiber tows with a matrix slurry and winding the saturated tows onto a preform mandrel as a unit at a pitch that abuts adjacent ribbons without overlapping.

53. The method of claim 1, further comprising saturating the coated fiber tows with a matrix slurry, forming the tows into a preform and consolidating the preform.

54. A coating system, comprising:
a reactor chamber to accommodate a multiplicity of fiber tows passing along a path substantially parallel to a longitudinal axis of the chamber and a flow of fiber coating reactant; and
an aligning structure at an end of the chamber to maintain the multiplicity of fiber tows in a narrow, elongated ribbon configuration.

55. The coating system of claim 54, wherein the aligning structure maintains the fiber tows in an aligned, spaced apart ribbon configuration.

56. The coating system of claim 54, wherein the aligning structure maintains the fiber tows in a parallel relationship, separated by spacings of about 0.5 mm to about 25 mm.

57. The coating system of claim 54, wherein the aligning structure maintains the fiber tows in a parallel relationship, separated by spacings of about 0.625 mm to about 10 mm.

58. The coating system of claim 54, wherein the aligning structure maintains the fiber tows in a parallel relationship, separated by spacings of about 0.9 mm to about 6 mm.

59. The coating system of claim 54, wherein the reactor chamber is a CVD reactor chamber.

60. The coating system of claim 54, comprising at least one flow disrupter located within the reactor chamber.

61. The coating system of claim 54, wherein the aligning structure comprises a plurality of pulleys.

62. The coating system of claim 54, further comprising a furnace to pretreat the fiber tows prior to winding onto a spool prior to passing the tows as a multiplicity into the reactor chamber.

63. The coating system of claim 62, wherein the aligning structure aligns and spaces the fiber tows for winding onto the spool.

64. The coating system of claim 54, further comprising a tensioning structure that applies a uniform tension to the tows prior to passing the tows as a multiplicity into the reactor chamber.

65. An article, comprising a multiplicity of fiber tows aligned in a longitudinal planar array in the form of a ribbon.

66. The article of claim 65, comprising said fiber tows aligned and held in the form of a ribbon by a polymethylmethacrylate binder.

67. The article of claim 65, comprising the multiplicity of fiber tows aligned and held in ribbon form by weaving, stitching or braiding.

68. The article of claim 65, comprising the multiplicity of fiber tows aligned and held in ribbon form by woven or stitched secondary fibers.

69. The article of claim 65, comprising the multiplicity of fiber tows held in ribbon form by woven or stitched secondary fibers made from thermodynamically stable oxides, carbides and nitrides.

70. The article of claim 65, comprising the multiplicity of fiber tows aligned onto a supporting co-aligned spacer base tape.

71. The article of claim 65, comprising the multiplicity of fiber tows aligned onto a supporting co-aligned spacer base tape comprising a polymer film, a paper strip or a metal foil.
